(19) United States
(12) Patent Application Publication
(10) Pub. No.: US 2014/0132572 A1
(43) Pub. Date: May 15, 2014

(54) TOUCH-SENSITIVE DISPLAY

(71) Applicants: Niko Rusanen, Helsinki (FI); Claus Ingman, Riihimaki (FI)

(72) Inventors: Niko Rusanen, Helsinki (FI); Claus Ingman, Riihimaki (FI)

(73) Assignee: Kone Corporation, Helsinki (FI)

(21) Appl. No.: 14/116,559

(22) PCT Filed: Dec. 23, 2011
(86) PCT No.: PCT/FI11/51152

§ 371 Date: Nov. 8, 2013

(30) Foreign Application Priority Data
Dec. 30, 2010 (FI) 20106383

(51) Int. Cl. G06F 3/041

(52) U.S. Cl. CPC G06F 3/0418
USPC 345/178

(57) ABSTRACT

The present invention discloses a method for the automatic calibrating of a touch-sensitive display, and also a touch-sensitive display. The touch-sensitive display comprises a display element, a plurality of force sensors for measuring the forces acting on the display element, and also a plurality of force components for producing forces acting on the display element. When a calibration need of the touch-sensitive display is verified, forces acting on the display element are produced with force components, the responses caused by the forces produced with the force components are measured with the force sensors, and calibration parameters are determined on the basis of the responses measured with the force sensors and on the basis of the position data of the force components.

The present invention relates to touch-sensitive displays. More particularly the invention relates to the automatic calibration of touch-sensitive displays.

### BACKGROUND OF THE INVENTION

Touch-sensitive displays are used to an ever-increasing degree in, among other things, mobile terminals, calculators, computers and in guidance and other such displays situated in public spaces. Touch-sensitive displays are formed, in terms of their structure, from an actual display element, e.g. from an LCD display, and also from sensors detecting the touch of a user, e.g. from piezoelectric sensors. The surface of the display element, which a user touches, is e.g. of glass. In these types of touch-sensitive displays the force or vibration produced by the touch of a user is detected with the aforementioned sensors that are in connection with the display element. The measuring signals produced by the sensors are conveyed to a control unit, which converts the measuring signals into position data (position coordinates) determining the contact point. For converting measuring signals into position data a plurality of calibration parameters are recorded in the control unit, which calibration parameters have been determined e.g. in the manufacturing phase of the touch-sensitive display and/or after it, depending on the permanency of the calibration.

One advantage of the piezoelectric sensors (piezo sensors) often used in touch-sensitive displays is their durability in use and also the fact that objects glued to the surface of the display element and the objects continually touching them do not prevent operation of the touch-sensitive display. The sensors to be used in touch-sensitive displays are often susceptible to various error factors such as impacts, temperature fluctuations, deformation of components and humidity fluctuations. Touch-sensitive displays are particularly susceptible to the aforementioned error factors in public spaces, such as e.g. in elevators. In this case the sensors of a touch-sensitive display can lose their calibration and the touch-sensitive display must be re-calibrated. Calibration occurs e.g. such that pushbuttons are displayed at different points on the touch-sensitive display, which pushbuttons a user must press either with a finger or with a suitable, e.g. pencil-like, object. The control unit in connection with the touch-sensitive display registers the touches of the user and determines new calibration parameters to correspond to the changed situation. Since calibration is a manual procedure, the accuracy of it depends on the person performing it and can easily result in inaccurate calibration. In the case of touch-sensitive displays disposed in public spaces, manual calibration cannot be required of a user, but instead e.g. a serviceman must perform the calibration. A visit by a serviceman for calibration will, however, be considerably expensive. In addition, owing to intense temperature fluctuations or other environmental factors, visits must be made often. A changed calibration can also prevent use of a system, e.g. an elevator system, in connection with a touch-sensitive display up until a serviceman arrives on site and re-calibrates the touch-sensitive display.

Another problem of touch-sensitive displays is the response connected to a touch, on the basis of which response a user could sense that the touch has succeeded. An auditive response is generally used as a response in solutions according to prior art. Solutions are also known in the art, wherein an actuator is connected in connection with a touch-sensitive display, by the aid of which actuator a suitable vibration can be produced on the surface of the display element when a user touches it (so-called haptic contact feedback). The use of an auditive response can be problematic in spaces in which there is disturbing ambient noise. Arranging haptic contact feedback in a touch-sensitive display, for its part, complicates the touch-sensitive display and can considerably increase its price.

### AIM OF THE INVENTION

The aim of the present invention is to solve the problems connected to a prior art touch-sensitive display and to achieve a touch-sensitive display solution that is versatile in terms of its properties and at the same time is inexpensive.

With regard to the characteristic attributes of the present invention reference is made to the claims.

### SUMMARY OF THE INVENTION

The method according to the invention is characterized by what is disclosed in the characterization part of claim 1. The touch-sensitive display according to the invention is characterized by what is presented in the characterization part of claim 7. Other embodiments of the invention are characterized by what is presented in the other claims. Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the scope of the basic inventive concept in conjunction with other embodiments.

The present invention discloses a method for the automatic calibrating of a touch-sensitive display. The touch-sensitive display comprises a display element, a plurality of force sensors for measuring the forces acting on the display element, and also a plurality of force components for producing forces acting on the display element. The method comprises the phases: the calibration need of the touch-sensitive display is verified; forces acting on the display element are produced with the force components; the responses caused by the forces produced in the display element are measured with the force sensors, and new calibration parameters are determined on the basis of the responses measured with the force sensors and on the basis of the position data of the force components.

The term force component refers to any component whatsoever that produces a desired force on a known point of the display element. The force can be either a static or a dynamic force. A static force produces a static response in the force sensors that is proportional to the magnitude and position of the force. A dynamic force is a momentary, e.g. impact-type, force, the response caused by which is e.g. a vibration propagating along the surface of the display element, which vibration can be measured with force sensors and used for determining the contact point. A force component is e.g. a piezoelectric or electromagnetic component. By producing a force in a display element with each force component one at a time, a number of measurement results that are independent of each other are obtained, in which case the determination accuracy of the calibration parameters improves.

The invention also presents a touch-sensitive display, which comprises a display element, a plurality of force components in connection with the display element, a plurality of force sensors in connection with the display element, and also a control unit, which is connected to the aforementioned force components and to the aforementioned force sensors. The control unit is arranged: to verify the calibration need of the touch-sensitive display; to control each force component for producing forces acting on the display element; to measure with the force sensors the responses caused by the aforementioned forces; and to determine the calibration parameters of the touch-sensitive display on the basis of the responses measured and on the basis of the position data of the aforementioned force components.

In one embodiment of the invention at least one of the aforementioned force sensors and at least one of the aforementioned force components is integrated into the same component. The same combination component can be used in an embodiment both for producing a force and for measuring the force, in which case the structure of the touch-sensitive display can be simplified and it can be made to be compact. Components suited for the purpose are e.g. piezoelectric components.

In one embodiment of the invention a pressing of the touch-sensitive display performed by a user is verified and contact feedback is given to the user using at least one aforementioned force component. As a result of the embodiment, the structure of the touch-sensitive display can be simplified and it can be made to be compact, because the same component can be used both for calibrating and for generating contact feedback.

In one embodiment of the invention statistical data is collected about the measured position coordinates of contact points and the statistical displacement of contact points as a function of time is determined, when the keying areas (pushbuttons) are situated in the same points on the display element. If the statistical displacement exceeds a predefined limit value, a calibration need of the touch-sensitive display is verified. In the embodiment, the statistical distribution of the contact points is measured when each area, i.e. pushbutton, of the touch-sensitive display is pressed such that it becomes selected. As a result of the embodiment, erroneous calibration can be detected quickly and automatically.

In one embodiment of the invention the touch-sensitive display is verified to be free for performing a calibration on the basis of clock time and/or on the basis of data produced by a system connected to the touch-sensitive display. If it is known that a touch-sensitive display is not used at a certain time of day, e.g. at night-time, the calibration of the touch-sensitive display can be performed on the basis of a clock time. A touch-sensitive display can also receive status data about the system to be controlled and on the basis of the status data draw conclusions about whether the touch-sensitive display can be calibrated. For example, if a touch-sensitive display is the call-giving panel of an elevator, said display can receive status data from the control system of the elevator, which control system expresses one or more of the following items of information: the elevator car is empty, the door of the elevator car is closed, the elevator does not have any active calls to be served, the elevator car is standing at a floor level.

As a result of the invention, the number of servicing visits required by a touch-sensitive display can be significantly reduced, the calibration accuracy can be improved, and also the touch-sensitive display can be simplified by integrating a number of functionalities into the same components.

### LIST OF FIGURES

FIG. 1 presents a diagram of a touch-sensitive display according to the present invention, and

FIG. 2 presents a method according to the present invention for the automatic calibration of a touch-sensitive display.

### DETAILED DESCRIPTION OF THE INVENTION

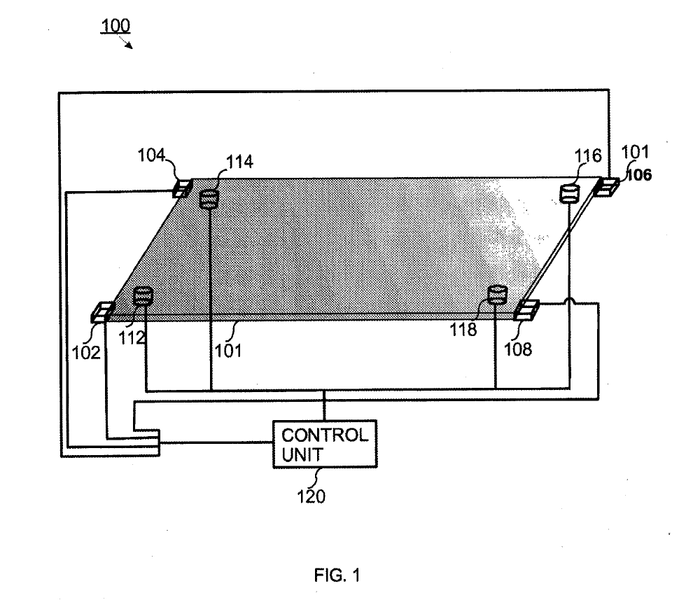

FIG. 1 presents a touch-sensitive display 100 according to the present invention. The touch-sensitive display 100 comprises a display element 101, in connection with which, preferably at the corners, are arranged or fixed force components 112, 114, 116 and 118. In FIG. 1 the display element 101 is described in a horizontal attitude, but from the viewpoint of the invention the attitude can be arbitrary. For calculating the position coordinates of the contact points, an X-Y coordinate system is “attached” to the display element, in which coordinate system the X-axis is e.g. in the direction of the longer edge of the display element and the Y-axis is in the direction of the shorter edge of the display element. The force components are disposed e.g. at the corners of the display element such that they are hidden inside the frame of the display element (the frame is not presented in FIG. 1). The force components are made e.g. of a piezoelectric material, which changes its shape under the effect of electrical voltage. The force components are connected to the control unit 120 for transmitting control signals from the control unit to the force components. A plurality of force sensors is also fixed to the display element 101, which force sensors measure the forces acting on the display element, which forces are caused by the touches on the display element of a user as well as by the forces produced with the force components. In FIG. 1 the force sensors 102, 104, 106 and 108 are fixed to the corners of the display element, and they are e.g. pietzo sensors or sensors based on electromagnetism. The force sensors are connected to the control unit 120, which receives the measuring signal of each piezo sensor, which measuring signal is proportional to the magnitude of the force acting on the display element and also to the position of the display element at which the force is acting. On the basis of the measuring signals and on the basis of the calibration parameters recorded in the control unit, the control unit can determine in a normal operating situation the contact point at which a user presses the display element. According to one embodiment of the invention a force sensor and a force component that are in at least one corner are integrated into the same component such that the component can be used sometimes as a force sensor and sometimes as a force component.

In one embodiment of the invention the force components 112, 114, 116 and 118 are also used to give to a user haptic contact feedback when the user presses some spot marked on the display element as a pushbutton. The user detects the contact feedback in his/her fingertip either as a vibration of the surface of the display element or as an impact-like movement. Contact feedback is a signal to the user e.g. about the fact that he/she has successfully pressed some pushbutton presented on the display element.

In FIG. 1, automatic calibration occurs such that one at a time, in a sequence known to the control unit 120, the force components produce a force in the display element, the position data of which force is recorded in the memory of the control unit. For example, first the desired force is produced in the display element with the force component 112 and the responses caused by the force in question are measured either with all four force sensors or at least with the force sensors 104, 106 and 108 in the other corners. Next, a force is produced with the force component 114 and the responses to the force in question are measured the force sensors 106, 108 and 102, and so on. Since the control unit has in its knowledge the position coordinates of the force components, it can by means of the measured responses determine the new calibration parameters.

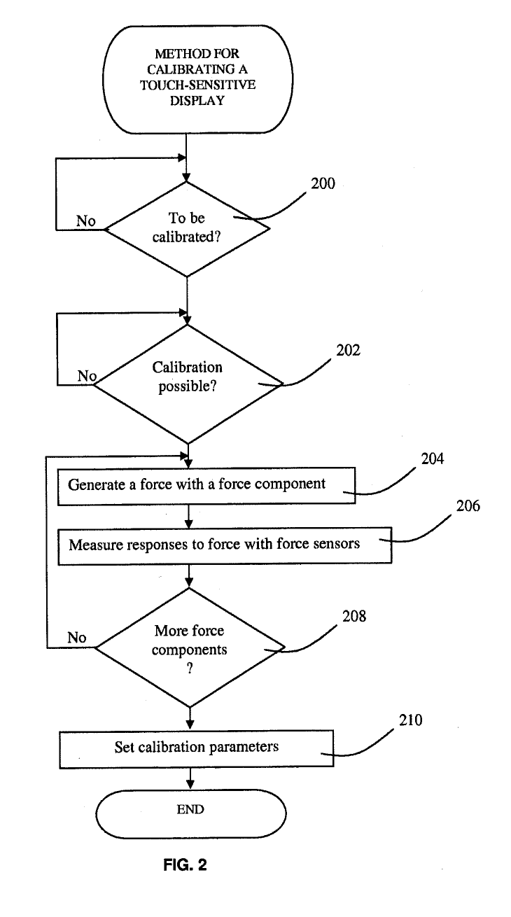

FIG. 2 presents a method according to the present invention for the automatic calibration of a touch-sensitive display.

In the phase 200 it is examined whether the touch-sensitive display must be calibrated, e.g. whether the preset time since the last calibration has expired. A calibration need can also be verified on the basis of statistical data, as presented below. A calibration need can also be verified by producing with some force component a force in the display element, by determining the contact point of the force, and by comparing the position data thus determined to the position data of the force component recorded in the memory of the control unit. If in the phase 200 a calibration need is verified, phase 202 of the method comes next.

In the phase 202 it is examined whether calibration can be performed, and if it can phase 204 comes next. In the phase 202 it can be examined, for example, whether the touch-sensitive display has been unused for a certain time and/or whether it is a time of day in question when calibration can be performed. When using a touch-sensitive display e.g. for giving calls in an elevator car, it can be examined by means of the car load weighing device whether the elevator car is empty, and if it is an automatic calibration can be performed. Another possible obstacle for the calibration of a touch-sensitive display of an elevator can be e.g. one of the following: the elevator car is moving, the elevator has at least one unserved elevator call, or the door of the elevator car is open. For reading the aforementioned status data connected to an elevator, the control unit of the touch-sensitive display can be connected to the control system of the elevator, which control system conveys the necessary status data to the control unit of the touch-sensitive display.

In the phase 204 a force acting on the display element is produced with the desired force component. The force produced is either a static force or a dynamic force.

In the phase 206, the response caused by the force produced in the display element with the force sensors is measured and the measuring data is recorded in the memory of the control unit 120 for calculating the calibration parameters. If the force produced is a static force, an individual measurement result from each force sensor is recorded. If the force produced is a dynamic force, a time series of the measurement results from each force sensor is recorded, which time series determines the specific characteristics of vibration caused in the display element by the force.

In the phase 208 it is checked whether all the force components were used for producing the force. If this is not the case, the phase 204 is reverted to and a force acting on the display element is produced with the next force component in the sequence.

In the phase 210 the control unit calculates new calibration parameters on the basis of the recorded measurement data and on the basis of the position data of the force components. On the basis of the new calibration parameters, the control unit is able after this to determine in a normal operating situation the contact point of a user to correspond to the changed properties of the touch-sensitive display.

As presented above, a touch-sensitive display can be calibrated at desired intervals of time, e.g. once per 24-hour period. The control unit can also collect statistical data about the pressings made by users and detect the statistical displacement of contact points as a function of time, when the keying areas or pushbuttons are situated always in the same points on the display element. In this case the statistical average of the measured position coordinates of each contact can be calculated, when each area, i.e. pushbutton, of the touch-sensitive display is pressed such that it becomes selected. The statistical displacement of a contact point in relation to time is measured, and if the displacement exceeds a predefined limit value, e.g. the displacement is over 10 mm with respect to the reference coordinates, it can be deduced that the touch-sensitive display must be re-calibrated.

The invention is not only limited to be applied to the embodiments described above, but instead many variations are possible within the scope of the inventive concept defined by the claims. Thus, for example, the force sensors and the force components do not necessarily need to be fixed to the display element itself, but instead fixing elements or other fixing solutions suited to the purpose can be used for the fixing. The control unit of the touch-sensitive display can also be integrated, either partly or wholly, into the system to be controlled with the touch-sensitive display, in which case the total costs of the system can be reduced.

1. A method for calibrating a touch-sensitive display, which touch-sensitive display comprises a display element, a plurality of force sensors for measuring the forces acting on the display element, and a plurality of force components for producing forces acting on the display element, the method comprising:
verifying the calibration need of the touch-sensitive display;
producing forces acting on the display element with force components;
measuring the responses caused by the forces produced with the force components with the force sensors; and
determining calibration parameters on the basis of the responses measured with the force sensors and on the basis of the position data of the force components.

2. The method according to claim 1, further comprising using a component in at least one point of the display element is used for producing a force and for measuring the force, wherein the component can functions as one of a force sensor or a force component.

3. The method according to claim 1, further comprising producing forces acting on the display element are produced by controlling one at a time each force component.

4. The method according to claim 1, wherein the verifying step includes verifying the touch-sensitive display is verified to be free for performing a calibration on the basis of at least one of a clock time and status data produced by a system connected to the touch-sensitive display.

5. The method according to claim 1, further comprising collecting statistical data about the contact points; and identifying a calibration need if, on the basis of the statistical data, a displacement of at lease one contact point exceeds a given limit value.

6. The method according to claim 1, further comprising: verifying a pressing of the touch-sensitive display performed by a user; and giving contact feedback the user using at least one of the said force components.

7. A touch-sensitive display, comprising; a display element; a control unit; a plurality of force sensors coupled with the display element, and connected to the control unit; and a plurality of force components arranged on the display element and connected to the control unit, wherein the control unit is operative to:
verify a calibration need of the touch-sensitive display;
produce with the force components forces acting on the display element;
to measure with the force sensors responses caused by the forces produced with the force components; and
determine calibration parameters of the touch-sensitive display on the basis of responses measured with the force sensors and on the basis of position data of the force components stored in the control unit.

8. The touch-sensitive display according to claim 7, wherein at least one of said force sensors and at least one of said force components is integrated into a same component.

9. The touch-sensitive display according to claim 7, wherein the control unit is arranged to control each force component one at a time for producing forces acting on the display element.

10. The touch-sensitive display according to claim 7, wherein the control unit is arranged to verify that the touch-sensitive display is free for performing a calibration on the basis of at least one of clock time and status data produced by a system connected to the touch-sensitive display.

11. The touch-sensitive display according to any claim 7, wherein the touch-sensitive display comprise a call-giving panel of an elevator.

12. The touch-sensitive display according to claim 7, wherein the control unit is arranged to give to a user contact feedback using at least one said force component when the control unit detects a touching of the display element performed by a user.

13. The touch-sensitive display according to any claim 7, wherein the control unit is arranged for collecting statistical data about the contact points, monitoring displacement of contact points on the basis of statistical data and to verify a calibration need if, on the basis of the monitoring, a contact point is displaced beyond a given limit value.
